(19) United States
(12) Patent Application Publication
(10) Pub. No.: US 2021/0044688 A1
(43) Pub. Date: Feb. 11, 2021

(54) MOBILE PHONE COMPRISING AN AUDIO SYSTEM HAVING A REAR-SIDE SECONDARY OPENING

(71) Applicant: USOUND GMBH, Graz (AT)

(72) Inventors: Andrea Rusconi Clerici Beltrami, Wien (AT); Ferruccio Bottoni, Graz (AT)

(21) Appl. No.: 16/986,875

(22) Filed: Aug. 6, 2020

(30) Foreign Application Priority Data
Aug. 6, 2019 (DE) 102019121258.8

(51) Int. Cl. H04M 1/03; H04R 1/28; H04R 17/00

(52) U.S. Cl. CPC H04M 1/035; H04R 2499/11; H04R 17/00; H04R 1/2826

(57) ABSTRACT

A mobile phone includes a housing defining a front side, a touchscreen on the front side, and an audio system integrated into the housing. The audio system includes a first hollow space having a primary opening adjacent the touchscreen, a second hollow space, and a loudspeaker between the two hollow spaces. First sound waves are emitted from the loudspeaker to an ear of a user via the primary opening when the mobile phone is used as intended. The second hollow space has a secondary opening on a back side of the housing opposite the front side. The loudspeaker emits second sound waves via the secondary opening away from the ear into the ear's surroundings. The second sound waves are phase-shifted from the first sound waves and the sound level of the sound waves emitted by the audio system into the surroundings can be reduced.

### FIELD OF THE INVENTION

The present invention relates to a mobile phone comprising a housing, a touchscreen arranged on a front side of the housing, and an audio system integrated into the housing, which audio system reduces the environmental sound reaching the user's ear when the mobile phone is used as intended.

### BACKGROUND OF THE INVENTION

With respect to mobile phones known from the related art, the primary opening of the integrated audio system is located on the front side of a housing. During a telephone call, the ear of the user is therefore situated essentially over the primary opening, and so the primary opening is acoustically sealed by the auricle of the user, in a manner comparable to a headphone. This is referred to as the “headphone effect”. As a result, it can be ensured that the sound waves emitted via the primary opening largely enter the ear and only a negligibly small portion is emitted into the surroundings. It is disadvantageous, however, that a portion of the front side of the housing is lost due to the primary opening and that the entire front side of the housing cannot be utilized as a touchscreen.

The problem addressed by the present invention is therefore that of creating a mobile phone comprising an audio system, with the aid of which the area of the touchscreen can be maximized and the situation is avoided in which the audio information transmitted to the user are perceptible by persons located in the surroundings.

The problem is solved with the aid of a mobile phone and an audio system having the features described below.

### OBJECTS AND SUMMARY OF THE INVENTION

The invention relates to a mobile phone, in particular a smartphone, comprising a housing, a touchscreen arranged on the front side of the housing, and an audio system integrated into the housing. The audio system comprises a first hollow space including a primary opening. The primary opening is preferably adjacent to the touchscreen. Moreover, the audio system comprises a second hollow space and a first loudspeaker arranged between the two hollow spaces. The first loudspeaker therefore separates the two hollow spaces from one another. With the aid of the first loudspeaker, first sound waves can be emitted to an ear of a user via the primary opening when the mobile phone is used as intended. The second hollow space comprises a secondary opening. Sound waves can also be emitted via this secondary opening. The secondary opening is arranged on a back side of the housing opposite the front side. The primary opening and the secondary opening are therefore oriented in different directions with respect to one another. When the mobile phone is used as intended, second sound waves can be emitted away from the ear via the secondary opening into the surroundings with the aid of the first loudspeaker. The second sound waves are phase-shifted with respect to the first sound waves in such a way that the sound level of the sound waves given off by the audio system into the surroundings can be reduced. Advantageously, the primary opening therefore no longer needs to be arranged on the front side of the housing. Instead, the primary opening can now also be arranged at a spot of the housing at which the primary opening is no longer completely covered by the auricle of the user during a telephone call. Advantageously, the area of the touchscreen can therefore be maximized. Moreover, the privacy of the user is ensured, since telephone calls cannot be overheard by third parties located in the surroundings.

It is advantageous when the front side and/or the touchscreen are/is designed to be planar, in particular exclusively and/or on the entire surface. Moreover, it is advantageous when the touchscreen extends at least across the entire front side, in particular without gaps and/or completely. As a result, the user can utilize the entire front side of the housing as a touchscreen.

It is also advantageous when the housing comprises a frame side and/or frame area, which connects the front side to the back side. The frame side can be, in particular, convex, curved, or planar. An edge can be formed between the frame side and the adjacent front side and/or back side.

It is advantageous when the primary opening is arranged in the frame side and/or in the edge. As a result, the entire front side of the housing can be utilized as a touchscreen.

In order to ensure that as many of the first sound waves as possible are emitted via the primary opening in the direction of the ear of the user, it is advantageous when the primary opening is arranged, in particular directly, at the screen edge of the touchscreen and/or is oriented in the direction of the ear.

It is advantageous when the primary opening, in a side view of the mobile phone, is arranged at a first level in the direction of a longitudinal axis of the housing and the secondary opening is arranged at a second level, which is lower than the first level. As a result, the distance that the sound must cover from a diaphragm of the loudspeaker up to the secondary opening can be increased as compared to the distance that the sound must cover from the diaphragm up to the primary opening.

In an advantageous enhanced embodiment of the invention, the secondary opening is spaced apart from the primary opening in the direction of the longitudinal axis of the housing. The primary opening and the secondary opening are therefore not arranged at the same level, but rather at different levels with respect to one another.

Advantageously, the primary opening is arranged over the touchscreen in the direction of the longitudinal axis of the housing. The secondary opening is preferably arranged underneath the primary opening in the direction of the longitudinal axis of the housing. The secondary opening is therefore arranged opposite the touchscreen in the transverse direction of the housing.

It is advantageous when the first loudspeaker is a woofer.

It is also advantageous when the first loudspeaker is arranged in the housing in such a way that a first stroke axis of the first loudspeaker, along which a first diaphragm of the first loudspeaker can be deflected, is slanted with respect to the longitudinal axis of the housing, in particular by 90°. The first diaphragm of the first loudspeaker therefore extends essentially along the longitudinal axis of the housing.

It is advantageous when a first length between the first stroke axis and the primary opening is less than a second length between the first stroke axis and the secondary opening, in the direction of the longitudinal axis of the housing. Consequently, the distance that the sound must cover from the diaphragm up to the primary opening is less than the distance that the sound must cover from the diaphragm up to the secondary opening.

In an advantageous enhanced embodiment of the invention, the audio system comprises a second loudspeaker, which is smaller, in particular, than the first loudspeaker. The second loudspeaker is preferably a tweeter. Moreover, the second loudspeaker is preferably arranged in the housing in such a way that a second stroke axis of the second loudspeaker, along which a second diaphragm of the second loudspeaker is deflectable, extends in parallel to the longitudinal axis of the housing.

It is advantageous when the first stroke axis and the second stroke axis of the two loudspeakers are slanted with respect to one another, in particular by 90°.

In an advantageous enhanced embodiment of the invention, the first loudspeaker and the second loudspeaker comprise first hollow spaces and/or primary openings, which are separated from one another.

It is advantageous when the two primary openings of the two loudspeakers are arranged next to one another or one above the other with respect to the longitudinal axis of the housing at an outer side of the housing.

In order to reduce the area of the primary openings at the outer side of the housing, it is advantageous when the two first hollow spaces are combined in an end region, and so the two loudspeakers comprise a common primary opening.

It is advantageous when the first loudspeaker and the second loudspeaker comprise a common second hollow space and/or a common secondary opening. The second hollow space therefore forms a cavity of the first loudspeaker as well as of the second loudspeaker.

The audio system can be designed to be highly compact when the first loudspeaker and/or the second loudspeaker are/is an, in particular piezoelectric, MEMS loudspeaker. Preferably, the MEMS loudspeaker comprises a support substrate, in particular made up of silicon, as well as a piezoelectric actuator for deflecting the diaphragm.

It is advantageous when the second hollow space is formed by a substrate hollow space of the support substrate and a housing hollow space of the housing. As a result, the cavity of the MEMS loudspeaker can be maximized.

It is advantageous when the audio system comprises a control unit electrically connected to the loudspeaker, in particular for acoustic beam shaping.

Moreover, the invention relates to an audio system for a mobile phone, which comprises a first hollow space including a primary opening, a second hollow space, and a first loudspeaker arranged between the two hollow spaces and separating these from one another, with the aid of which first sound waves can be emitted to an ear of the user via the primary opening when the phone is used as intended. The audio system is designed for use in a mobile phone according to the preceding description, wherein the mentioned features can be present individually or in any combination.

### BRIEF DESCRIPTION OF THE DRAWINGS

Aspects and advantages of the invention are set forth below in the following description, or may be obvious from the description, or may be learned through practice of embodiments of the invention. Those of ordinary skill in the art will better appreciate the features and aspects of such embodiments, and others, upon review of the specification. A full and enabling disclosure of the present invention, including the best mode thereof to one skilled in the art, is set forth more particularly in this specification, including reference to the accompanying figures, in which:

FIG. 1 shows a mobile phone in a front view comprising a primary opening and a secondary opening, and

FIG. 2 shows a cross-section of the mobile phone in the region of an audio system.

The accompanying drawings, which are incorporated in and constitute a part of this specification, illustrate at least one presently preferred embodiment of the invention as well as some alternative embodiments. These drawings, together with the written description, explain the principles of the invention but by no means are intended to be exhaustive of every possible embodiment of the invention.

### DETAILED DESCRIPTION OF EXEMPLARY EMBODIMENTS

Reference will now be made in detail to present exemplary embodiments of the invention, wherein one or more examples of which are illustrated in the accompanying drawings. The detailed description uses numerical and/or letter designations to refer to features in the drawings. Like or similar designations in the drawings and description have been used to refer to like or similar parts of the embodiments of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

It is to be understood that the ranges and limits mentioned herein include all sub-ranges located within the prescribed limits, inclusive of the limits themselves unless otherwise stated. For instance, a range from 100 to 1200 also includes all possible sub-ranges, examples of which are from 100 to 150, 170 to 190, 153 to 162, 145.3 to 149.6, and 187 to 1200. Further, a limit of up to 7 also includes a limit of up to 5, up to 3, and up to 4.5, as well as all sub-ranges within the limit, such as from about 0 to 5, which includes 0 and includes 5 and from 5.2 to 7, which includes 5.2 and includes 7.

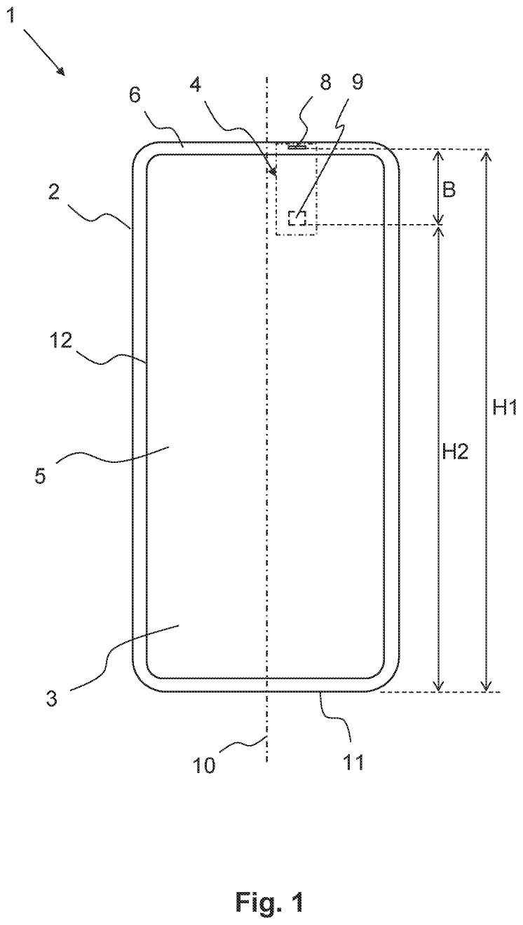

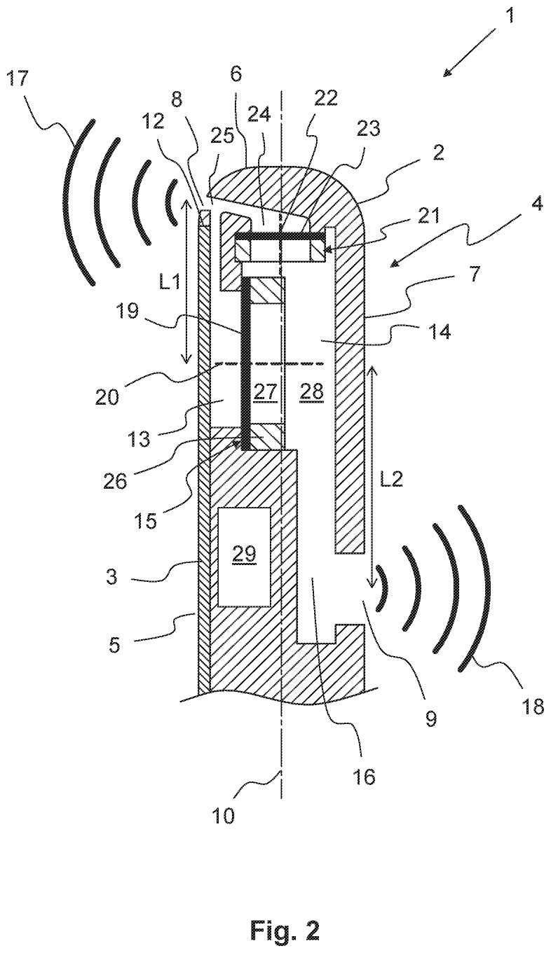

FIG. 1 shows a mobile phone 1 in a front view. The mobile phone 1 comprises a housing 2, a touchscreen 3, and an audio system 4. The audio system 4 is completely integrated into the housing 2, which defines a front side 5 and a back side 7 (FIG. 2) disposed opposite the front side 5. The touchscreen 3 is arranged on the front side 5 of the housing 2. The front side 5 as well as the touchscreen 3 are designed to be planar. The touchscreen 3 extends across the entire front side 5, in particular without gaps and/or completely.

As is apparent from the figures, the housing 2 comprises a side frame 6, which connects the front side 5 to the back side 7 of the housing represented in FIG. 2. As shown in FIG. 2, the side frame 6 is convexly curved in the present exemplary embodiment. In a side view shown in FIG. 2, the side frame 6 therefore extends from the planar front side 5 in a curve to the back side 7, which, in particular, is also designed to be planar.

The audio system 4, which is described in greater detail in the following, comprises a primary opening 8 and a secondary opening 9. As shown in FIG. 2, the primary opening 8 is adjacent to the touchscreen 3. The secondary opening 9 is arranged on the back side 7 of the housing 2. The primary opening 8 and the secondary opening 9 are therefore oriented in different directions with respect to one another. According to FIG. 1, the primary opening 8 and the secondary opening 9 are arranged at different levels with respect to one another along a longitudinal axis 10 of the housing 2. Accordingly, as schematically shown in FIG. 1, the primary opening 8 is arranged, in the direction of the longitudinal axis 10 of the housing 2, at a first level H1 relative to a lower end 11 of the housing 2. The secondary opening 9 is arranged, in the direction of the longitudinal axis 10 of the housing 2, at a second level H2 relative to the lower end 11 of the housing 2. The second level H2 is lower as compared to the first level H1. In other words, the secondary opening 9 is disposed at a first distance from the screen edge 12 of the touchscreen 3 that defines one side edge of the primary opening 8. Consequently, the secondary opening 9 is arranged underneath the primary opening 8. Relative to the longitudinal axis 10 of the housing 2, the primary opening 8 and the secondary opening 9 have a spacing B relative to one another.

As is apparent from FIGS. 1 and 2, the primary opening 8 is adjacent to a screen edge 12 of the touchscreen 3. Moreover, the primary opening 8 is located at the frame side 6 of the housing 2. Advantageously, as a result, the complete front side 5 of the housing 2 can be utilized for the touchscreen 3. An associated disadvantage, however, is that the primary opening 8, due to the edge-side arrangement, is no longer completely covered by an auricle (not represented in the present case) of a user during a telephone call. For this reason, with respect to such an arrangement of the primary opening 8, considerably more sound waves enter the surroundings, and so telephone calls can be overheard by persons located in the surroundings. In order to avoid this, the audio system 4 comprises, on the back side 7 of the housing 2, the additional secondary opening 9, which is configured in such a way that the sound level of the sound waves given off by the audio system 4 into the surroundings is reduced with the aid of a phase shift between the sound waves 17 emitted from the primary opening 8 and the sound waves 18 emitted from the secondary opening 9.

The exact mode of operation of the audio system 4 is explained in detail in the following with reference to FIG. 2, which shows a cross-sectional view of the mobile phone 1 in the region of the audio system 4. The audio system 4 comprises a first hollow space 13, a second hollow space 14, and a first loudspeaker 15 arranged between the two hollow spaces 13, 14. The first loudspeaker 15 therefore separates the first hollow space 13 from the second hollow space 14. The second hollow space 14 therefore forms the back volume or a cavity 16 of the first loudspeaker 15. The primary opening 8 is associated with the first hollow space 13. The primary opening 8 is, in particular directly, adjacent to the touchscreen 3. As is apparent from FIG. 2, the primary opening 8 is already located in a curved section of the housing 2, namely in the side frame 6.

When the mobile phone 1 is used as intended, the primary opening 8 faces toward the user's ear (not schematically represented in the figures), while the secondary opening 9 faces away from the user's ear and toward the environment that might be occupied by a third party trying to overhear what the user hears from the primary opening 8. The audio system 4 can emit, via the primary opening 8, first sound waves 17 generated by the first loudspeaker 15 to an ear of a user and/or at least partially in the direction of the front side 5 of the housing 2. Simultaneously, second sound waves 18 generated by the first loudspeaker 15 are emitted via the secondary opening 9 on the back side 7 of the housing 2. The second sound waves 18 are phase-shifted with respect to the first sound waves 17, in particular by 180°. The second sound waves 18 emitted into the surroundings therefore eliminate first sound waves 17 that have been inadvertently emitted into the surroundings. As a result, the sound level of the sound waves radiated by the audio system 4 into the surroundings is reduced, and so telephone calls cannot be overheard by third parties located in the surroundings.

As is apparent from FIG. 2, the first loudspeaker 15 comprises a first diaphragm 19, which can be deflected along a first stroke axis 20. The first loudspeaker 15 is arranged in the housing 2 in such a way that the first stroke axis 20 is slanted with respect to the longitudinal axis 10 of the housing 2. According to the present exemplary embodiment, the first stroke axis 20 is slanted by 90° with respect to the longitudinal axis 10, and thus lies in a direction that is orthogonal to the longitudinal axis 10. Consequently, in an undeflected rest mode, the first diaphragm 19 extends in plane that is parallel to the longitudinal axis 10. The first hollow space 13 is designed to be shorter in the direction of the longitudinal axis 10 as compared to the second hollow space 14. Consequently, the first sound waves 17 must cover a shorter distance starting from the first diaphragm 19 up to the primary opening 8 than the second sound waves 18 from the first diaphragm 19 up to the secondary opening 9. The first length L1 between the first stroke axis 20 and the primary opening 8, which extends in the direction of the longitudinal axis 10 of the housing 2, is therefore less than a second length L2 between the first stroke axis 20 and the secondary opening 9.

As is apparent from FIG. 2, the audio system 4 desirably comprises a second loudspeaker 21. The second loudspeaker 21 is designed to be smaller than the first loudspeaker 15. Moreover, the second loudspeaker 21 is preferably a tweeter. In contrast thereto, the first loudspeaker 15 is preferably a woofer. The first loudspeaker 15 and/or the second loudspeaker 21 can be designed as a MEMS loudspeaker.

The second loudspeaker 21 is arranged in the housing in such a way that a second stroke axis 22 of the second loudspeaker 21, along which a second diaphragm 23 is deflectable, extends in parallel to the longitudinal axis 10 of the housing 2. Consequently, the first loudspeaker 15 and the second loudspeaker 21 are arranged in the housing 2 rotated by 90° with respect to one another.

The second loudspeaker 21 comprises a hollow space, which is functionally identical to the above-described first hollow space 13 and is referred to in the following as the third hollow space 24. This third hollow space 24 is separated from the first hollow space 13. In a common end region 25, the first hollow space 13 and the third hollow space 24 are combined in communication with each other, and so insofar as these both emit sound waves to the primary opening 8 they comprise a common primary opening 8 in the illustrated embodiment. In an alternative exemplary embodiment that is not represented in the present drawings, the third hollow space 24 could comprise an additional separate primary opening. In this alternative case, the two primary openings 8 could be arranged next to one another or one above the other at the outer side of the housing 2.

As is apparent from FIG. 2, the two loudspeakers 15, 21 share the second hollow space 14 as well as the secondary opening 9. In an alternative exemplary embodiment that is not represented in the present drawings, the second loudspeaker 21 can also comprise a hollow space that is separated from the second hollow space 14 and forms the cavity of the second loudspeaker 21.

According to the present exemplary embodiment, the two loudspeakers 15, 21 are designed as MEMS loudspeakers, wherein only one of these two is provided with reference numbers in FIG. 2 for the sake of clarity. A MEMS loudspeaker of this type comprises a support substrate 26, which is preferably made up of silicon. A piezoelectric, actuator (not represented in the present drawings) for deflecting the diaphragm 19 is arranged at this support substrate 26. The support substrate 26 comprises a substrate hollow space 27, which, together with a housing hollow space 28, forms the second hollow space 14 or the cavity 16 of the first loudspeaker 15.

According to FIG. 2, the audio system 4 comprises a control unit 29. The control unit 29 is electrically connected to the first loudspeaker 15 and/or the second loudspeaker 21.

The present invention is not limited to the represented and described exemplary embodiments. Modifications within the scope of the claims are also possible, as is any combination of the features, even if they are represented and described in different exemplary embodiments.

### LIST OF REFERENCE NUMBERS

1 mobile phone
2 housing
3 touchscreen
4 audio system
5 front side
6 frame side
7 back side
8 primary opening
9 secondary opening
10 longitudinal axis
11 lower end
12 screen edge
13 first hollow space
14 second hollow space
15 first loudspeaker
16 cavity
17 first sound waves
18 second sound waves
19 first diaphragm
20 first stroke axis
21 second loudspeaker
22 second stroke axis
23 second diaphragm
24 third hollow space
25 end region
26 support substrate
27 substrate hollow space
28 housing hollow space
29 control unit
30 H1 first level
31 H2 second level
32 B spacing
33 L1 first length
34 L2 second length

What is claimed is:

1. A mobile phone comprising:
a housing defining a front side and a back side disposed opposite the front side;
a touchscreen arranged on the front side of the housing; and
an audio system integrated into the housing, wherein the audio system defines a first hollow space including a primary opening adjacent to the touchscreen, wherein the audio system defines a second hollow space, and wherein the audio system includes a first loudspeaker arranged between the two hollow spaces and separating the two hollow spaces from one another, wherein the first loudspeaker is configured to emit first sound waves to an ear of a user via the primary opening when the mobile phone is used as intended, wherein the second hollow space comprises a secondary opening, which is arranged on a back side of the housing, wherein the first loudspeaker is configured to emit second sound waves away from the ear of the user via the secondary opening and into the surroundings of the ear of the user, wherein the second sound waves are phase-shifted with respect to the first sound waves in such a way that the sound level of the sound waves given off by the audio system into the surroundings can be reduced.

2. The mobile phone as claimed in claim 1, wherein the front side and the touchscreen are designed to be planar.

3. The mobile phone as claimed in claim 1, wherein the housing comprises a side frame that is convexly curved and that connects the front side to the back side, and the primary opening is arranged in the side frame.

4. The mobile phone as claimed in claim 1, wherein the touchscreen defines a screen edge thereof, and the primary opening is arranged at the screen edge of the touchscreen.

5. The mobile phone as claimed in claim 4, wherein the housing elongates in a direction along a longitudinal axis with respect to the screen edge, wherein the secondary opening, in a side view of the mobile phone, is arranged at a first distance from the screen edge in the direction of the longitudinal axis of the housing.

6. The mobile phone as claimed claim 1, wherein the housing elongates in a direction along a longitudinal axis, wherein the secondary opening is spaced apart from the primary opening in the direction of the longitudinal axis of the housing.

7. The mobile phone as claimed in claim 1, wherein the housing elongates in a direction along a longitudinal axis, wherein the first loudspeaker is a woofer and is arranged in the housing in such a way that a first stroke axis of the first loudspeaker, along which a first diaphragm of the first loudspeaker can be deflected, is slanted by 90° with respect to the longitudinal axis of the housing.

8. The mobile phone as claimed in claim 7, wherein a first length between the first stroke axis and the primary opening, which first length extends in the direction of the longitudinal axis of the housing, is less than a second length between the first stroke axis and the secondary opening, which second length extends in the direction of the longitudinal axis of the housing.

9. The mobile phone as claimed in claim 1, wherein the audio system comprises a second loudspeaker, which is smaller than the first loudspeaker, which second loudspeaker is a tweeter and is arranged in the housing.

10. The mobile phone as claimed in claim 9, wherein the two first hollow spaces of the two loudspeakers are combined in an end region of the housing, which end region contains the first primary opening, and so the two loudspeakers emit sound waves through a common primary opening.

11. The mobile phone as claimed in claim 10, wherein the first loudspeaker and the second loudspeaker define a common second hollow space and a common secondary opening.

12. The mobile phone as claimed in claim 11, wherein each of the first loudspeaker and the second loudspeaker comprises a piezoelectric MEMS loudspeaker, and each of the piezoelectric MEMS loudspeakers share a support substrate.

13. The mobile phone as claimed in claim 12, wherein the second hollow space is formed by a substrate hollow space of the support substrate and a housing hollow space.

14. An audio system for a mobile phone, the mobile phone including a housing defining a front side and a back side disposed opposite the front side, a touchscreen arranged on the front side of the housing, the audio system comprising:
a first hollow space including a primary opening, a second hollow space and a first loudspeaker, which is arranged between the two hollow spaces and separates these from one another, and with the aid of which first sound waves can be emitted to an ear of a user via the primary opening when the mobile phone is used as intended, wherein the audio system is designed for use in a mobile phone as claimed in one or more of the preceding claims.

15. The mobile phone as claimed in claim 1, wherein the touchscreen extends across the entire front side of the housing.

16. The mobile phone as claimed in claim 1, wherein the housing comprises a side frame and the primary opening is defined in the side frame.

17. The mobile phone as claimed in claim 1, wherein the housing elongates in a direction along a longitudinal axis, wherein the audio system comprises a second loudspeaker, which is a tweeter and is arranged in the housing in such a way that a second stroke axis of the second loudspeaker, along which a second diaphragm of the second loudspeaker can be deflected, extends in a direction parallel to the longitudinal axis of the housing.
